(19) United States
(12) Patent Application Publication
(10) Pub. No.: US 2021/0032760 A1
(43) Pub. Date: Feb. 4, 2021

(54) FATIGUE-RESISTANT FLUIDIZED ELECTROCATALYSIS

(71) Applicant: Northwestern University, Evanston, IL (US)

(72) Inventors: Yige Zhou, Evanston, IL (US); Jiaxing Huang, Wilmette, IL (US); Yijin Kang, Naperville, IL (US)

(21) Appl. No.: 16/964,009

(22) PCT Filed: Jan. 30, 2019
(86) PCT No.: PCT/US2019/015772

§ 371 Date: Jul. 22, 2020

Related U.S. Application Data
(60) Provisional application No. 62/623,680, filed on Jan. 30, 2018.

(51) Int. Cl. C25B 1/02; C25B 3/02; B01J 23/38; C25B 9/06

(52) U.S. Cl. CPC C25B 1/02; C25B 3/02; B01J 35/0033; C25B 9/06; B01J 23/38

(57) ABSTRACT

Methods of catalyzing an electrochemical reaction are provided. In embodiments, such a method comprises applying an electrical potential across a fixed working electrode and a counter electrode, the fixed working electrode and the counter electrode in contact with an electrolyte solution comprising reactant species and fluidized electrocatalyst particles, the fluidized electrocatalyst particles undergoing free fluid motion within and throughout the electrolyte solution, wherein the electrical potential is applied to induce an electrochemical reaction between the reactant species and the fluidized electrocatalyst particles at transient interfaces formed between the reactant species, the fluidized electrocatalyst particles and the working electrode upon collisions of the fluidized electrocatalyst particles with the working electrode.

### CROSS-REFERENCE TO RELATED APPLICATIONS

The present application claims priority to U.S. Provisional Patent Application No. 62/623,680 that was filed Jan. 30, 2018, the entire contents of which are hereby incorporated by reference.

### BACKGROUND

Electrocatalytic materials are usually deposited on the surface of an inert electrode, which is then immersed in electrolyte to perform electrochemically driven reactions. Many of these reactions, such as methanol oxidation, hydrogen evolution, or oxygen reduction, are relevant to the development of efficient energy conversion and storage devices and facilities. A common problem in electrocatalysis is the rapid drop of catalyst performance (hereafter referred to as fatigue), which can be attributed to a number of material degradation mechanisms, such as surface poisoning from reaction intermediates, catalyst agglomeration and even sintering, and detachment or pulverization of active components from their support or the electrode. Fatigue greatly reduces catalyst efficiency, shortens catalyst lifetime, and greatly degrades long-term performance of the corresponding energy conversion and storage systems. Tremendous efforts have been made to make electrocatalysts more fatigue resistant. For example, the morphology of the catalytic particles can be tuned to expose their most active and robust crystallographic surfaces for the reactions. The surface states and chemical compositions of the catalysts can be adjusted such as by alloying, doping, and mechanical strains to improve their stability while maintaining catalytic activity. Support materials can also be customized to help prevent the catalyst nanoparticles from agglomeration and detachment. All of these strategies focus on improving the catalytic materials themselves. As a result, the corresponding solutions tend to be applicable only to a specific set of catalysts.

### SUMMARY

Provided are methods of catalyzing electrochemical reactions as well as electrochemical systems for carrying out the methods.

Methods of catalyzing an electrochemical reaction are provided. In embodiments, such a method comprises applying an electrical potential across a fixed working electrode and a counter electrode, the fixed working electrode and the counter electrode in contact with an electrolyte solution comprising reactant species and fluidized electrocatalyst particles, the fluidized electrocatalyst particles undergoing free fluid motion within and throughout the electrolyte solution, wherein the electrical potential is applied to induce an electrochemical reaction between the reactant species and the fluidized electrocatalyst particles at transient interfaces formed between the reactant species, the fluidized electrocatalyst particles and the working electrode upon collisions of the fluidized electrocatalyst particles with the working electrode.

Other principal features and advantages of the disclosure will become apparent to those skilled in the art upon review of the following drawings, the detailed description, and the appended claims.

### BRIEF DESCRIPTION OF THE DRAWINGS

Illustrative embodiments of the present disclosure will hereafter be described with reference to the accompanying drawings.

FIG. 1A shows that fixed electrocatalytic particles, such as Pt/C, can experience a number of fatigue mechanisms that are attributed to particle sintering, poisoning from intermediate species, detachment from the electrode, and diffusion limitation of electroactive molecules. FIG. 1B shows that in fluidized reaction, the particles are suspended in electrolyte and work in rotation. They catalyze the reaction only upon interacting with the electrode, making the overall reaction more fatigue resistant.

FIGS. 2A-2D illustrate the use of fluidized Pt/C catalyst particles in the methanol oxidation reaction (MOR). FIG. 2A shows a schematic drawing illustrating a fluidized reaction using a small glassy carbon electrode of 5 mm diameter. FIG. 2B shows transient current spikes generated by collision of Pt/C particles on the electrode (left), as observed in the segment of high-resolution chronoamperometric MOR (right, upper curve). No current was generated without Pt/C particles (right, lower curve). The insets show close-ups of representative current spikes, all of which were around 5-30 ms in duration. FIG. 2C shows that “long stay” particles (e.g., those gliding along the electrode surface upon collision) result in longer transient electrochemical current (i.e., wider current spikes), as observed in the corresponding segment of high-resolution chronoamperometric MOR (right). FIG. 2D shows a histogram of spike durations showing that 85% of spikes were shorter than 40 ms. A total of 205 spikes were analyzed to generate the histogram.

FIGS. 3A-3B illustrate scaling up the current output in fluidized MOR. FIG. 3A shows a typical chronoamperometric profile (right) from fluidized MOR using a larger glassy carbon plate with an immersed area of 500 mm² (left). FIG. 3B shows the effect of mass loading level on the MOR current output for both fixed and fluidized Pt/C catalyst. Note that the current was recorded at 500 s of both reactions, before significant degradation occurred for fixed catalyst.

FIGS. 4A-4E show results of fluidized Pt/C for MOR. FIG. 4A shows current output of MOR catalyzed by fixed and fluidized Pt/C over time under 0.7 V (vs. RHE). The electrocatalytic current from fixed Pt/C decayed to 40% of the initial value after only 7,000 s, while fluidized Pt/C delivered much more stable current and maintained 80% of the initial current even after 30,000 s. TEM images of (FIG. 4B) fixed Pt/C after 7,000 s of reaction clearly show that Pt nanoparticles had undergone significant restructuring and sintering. In contrast, FIG. 4C shows that the fluidized Pt/C particles remained unchanged, even after 150,000 s of reaction. FIGS. 4D-4E show histograms of fixed Pt particle diameter after 7,000 s of fixed MOR and 150,000 s of fluidized MOR, respectively.

FIGS. 5A-5E show results of fluidized electrocatalytic oxygen evolution reaction (OER). FIG. 5A shows current outputs of Pt/C catalyzed OER under fixed and fluidized conditions, and the fluidized catalysts delivered much more stable current. TEM images show that the Pt nanoparticles on fixed Pt/C (FIG. 5B) had undergone significant sintering after only 500 s of OER. In contrast, fluidized Pt/C (FIG. 5C) remained unchanged even after 60,000 s. FIGS. 5D-5E show histograms of fixed Pt particle diameter after 500 s of fixed OER and 60,000 s of fluidized OER, respectively.

FIGS. 6A-6B show results of fluidized electrocatalytic hydrogen evolution reaction (HER). FIG. 6A shows current outputs of Pt/C catalyzed HER under fixed and fluidized conditions, showing much higher stability of fluidized reaction. FIG. 6B shows top-view and side-view photos of a beaker after 10,000 s HER using fixed Pt/C catalyst. A significant amount of Pt/C sediment can be seen due to detachment from the electrode during gas evolution.

### DETAILED DESCRIPTION

Provided are methods of catalyzing electrochemical reactions as well as electrochemical systems for carrying out the methods.

In conventional electrocatalysis, electron transfer between an electrode and an electrocatalyst deposited on the electrode is coupled with a number of slower processes such as adsorption of reactants, conversion to intermediates, formation and then desorption of products, as well as mass transport (i.e., molecular diffusion) between the electrocatalyst surface and solution, all of which are convoluted at or near the surface of the electrocatalyst. Although an electrical field is only needed momentarily for the electron transfer step, in conventional electrocatalysis, it is constantly applied through the electrode. By contrast, the present disclosure is based, at least in part, on the inventors' understanding that the conventional approach exerts unnecessary extra electrochemical stress on electrocatalysts. The inventors further realized that the conventional approach is also an ineffective way to utilize electrocatalysts and the surface area of the electrode and inevitably accelerates the fatigue problem regardless of any improvement made to the catalytic materials themselves.

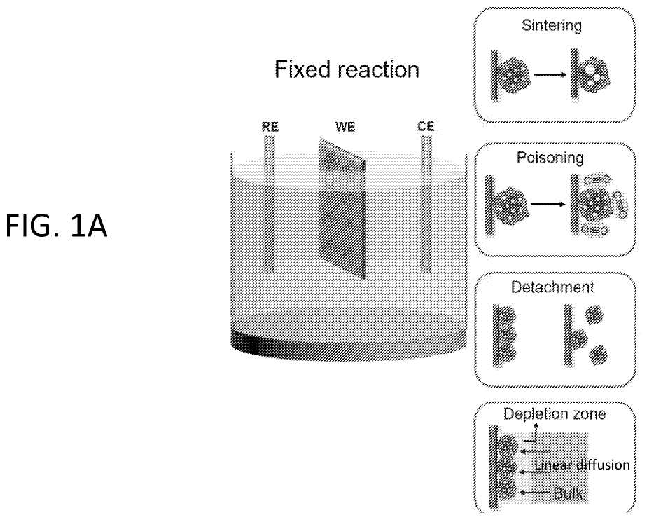

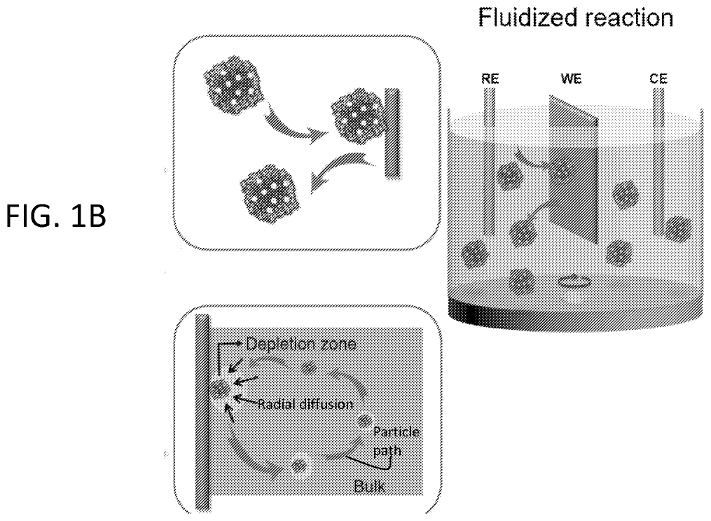

By contrast, the present disclosure is based on use of a fluidized strategy to achieve fatigue resistance in electrocatalysis. As illustrated in FIG. 1B, in the present methods, electrocatalysts are fluidized within an electrolyte solution. Reaction is catalyzed by individual catalytic particles only when they interact with the electrodes, which collectively delivers a continuous, stable and scalable electrochemical current output. Since individual electrocatalyst particles work in rotation, the time scale of the electrochemical stress applied to an electrocatalyst particle is drastically reduced, thus suppressing many common fatigue mechanisms. Moreover, since electron transfer between the electrode and the electrocatalyst particle is spatially and temporally decoupled from the other relatively slower steps (e.g., surface chemical reactions and mass transfer), fluidized electrocatalyst particles experience faster kinetics and are much more efficiently used. The Example, below, demonstrates that for three specific electrochemical reactions characterized by different fatigue mechanisms, fluidized electrocatalysis indeed delivers stable electrochemical performance over a drastically extended reaction time with negligible degradation of the electrocatalyst particles.

Thus, in one aspect, the present disclosure provides a method of catalyzing an electrochemical reaction. In an embodiment, the method comprises applying an electrical potential across a working electrode and a counter electrode, the working electrode and the counter electrode in contact with an electrolyte solution comprising a reactant species (e.g., reactant molecules, particles, etc.) and fluidized electrocatalyst particles. By “fluidized,” it is meant that the plurality of electrocatalyst particles are undergoing free fluid motion within and throughout the electrolyte solution. They are entirely separate and distinct from the electrodes themselves. The fluidized electrocatalyst particles of the present disclosure are by contrast to electrocatalyst particles are static or fixed, e.g., via deposition onto an underlying substrate material (e.g., of an electrode) which itself is static/fixed in the electrolyte solution. This is also by contrast to electrocatalyst particles which are in direct contact with other such particles in the form of a porous, conductive network (such a configuration may be known as a fluidized bed electrode). Electrocatalyst particles of a fluidized bed electrode are not fluidized as this term is defined in the present disclosure. The fluidized electrocatalyst particles of the present disclosure are isolated from other such particles, undergo free fluid motion within and throughout the electrolyte solution, are separate and distinct from the working electrode, and (as further described below) catalyze electrochemical reactions only upon collisions with the working electrode.

The working electrode and the counter electrode, including the materials making up these electrodes, may be static/fixed in the method. (This is by contrast to the materials of fluidized bed electrodes.) The electrical potential is applied under conditions to induce an electrochemical reaction at an interface formed between reactant species, the working electrode, and the fluidized electrocatalyst particles upon collisions of the particles with the working electrode.

The fluidized electrocatalyst particles may be characterized by their composition as well as the shape and dimensions of the particles and the density of the particles in the electrolyte solution. A variety of compositions, shapes, dimensions, and densities may be used, depending upon the electrochemical reaction to be carried out. However, as the reactions are electrochemical in nature, the composition of the electrocatalyst particles is one which is capable of undergoing electron transfer processes with the working electrode during application of the electric potential.

By way of illustration, an exemplary electrochemical reaction is the methanol oxidation reaction (MOR) in which methanol is oxidized to produce CO₂. Other exemplary electrochemical reactions include the hydrogen evolution reaction (HER), in which hydrogen (H₂) is produced via the electrolysis of water (H₂O), and the oxygen evolution reaction (OER), in which oxygen (O₂) is produced via the electrolysis of (H₂O). The phrase “electrochemical reaction” can encompass a reduction reaction or an oxidation reaction of an overall reaction, e.g., the reduction reaction of HER involving the reduction of hydrogen ions (the reactant) to H₂ (the product) as facilitated by the fluidized electrocatalyst particles at the reactant-working electrode-fluidized electrocatalyst particle interface. This interface is only formed upon collisions of the fluidized electrocatalyst particles with the working electrode and is thus, transient.

A noble metal such as Pt is a suitable electrocatalytic material for many electrochemical reactions, e.g., MOR, HER, and OER. Thus, the fluidized electrocatalyst particle may comprise a noble metal (e.g., Pt). However, fluidized electrocatalyst particles may comprise transition metals or alloys thereof; transition metal or other metal oxides, hydroxides, oxyhydroxides; transition metal or other metal carbides or nitrides; transition metal or other metal borides or phosphides; chalcogenide(s); metal-organic-framework materials; transition metal dichalcogenides; etc. The fluidized electrocatalyst particles may also comprise binders (e.g., ionomers), fillers (e.g., conductive carbon such as carbon black), etc.

The shape, dimensions, and concentration of the fluidized electrocatalyst particles may be selected to achieve a desired (e.g., maximum) activity and/or fatigue resistance and/or current decay rate (fatigue resistance and current decay rate are further described below). The concentration of the fluidized catalysts can be adjusted to yield desirable level of current output, up to a range where the catalyst particles can no longer be fluidized as that term has been defined above.

As noted above, the electrocatalyst particles undergo fluid motion within the electrolyte solution. Such motion may be facilitated by the use of a mechanism (and related device) as convection within the electrolyte solution or stirring, sonicating, pumping, etc. the electrolyte solution. These mechanisms/devices may be selected by applying a force to move the electrolyte solution. The type of mechanism/device, force, and relevant conditions (e.g., rpm, Hz, flow rate, etc.) may also be selected to achieve the desired activity and/or fatigue resistance and/or current decay rate.

The other components of the electrolyte solution, e.g., reactants, may be selected depending upon the electrochemical reaction to be carried out. By way of illustration, for MOR, the electrolyte solution may be an aqueous electrolyte solution comprising water, methanol, and a water-soluble electrolyte (e.g., H₂SO₄). For HER and OER, the electrolyte solution may be an aqueous electrolyte solution comprising water and a water-soluble electrolyte (e.g., H₂SO₄ (HER) or NaOH (OER)). Other additives may be included in the electrolyte solution, e.g., buffers to maintain a selected pH.

A variety of materials may be used for the counter electrode, again, depending upon the electrochemical reaction to be carried out. Platinum and carbon are suitable counter electrodes.

The conditions under which the electrochemical reaction between the fluidized electrocatalyst particles and the reactant is induced may refer to the applied electric potential (i.e., operating voltage), the temperature of the electrolyte solution, the pH of the electrolyte solution, etc. These will also vary depending upon the electrochemical reaction to be carried out and may be selected to achieve a desired activity and/or fatigue resistance. Illustrative conditions for MOR, HER, and OER are provided in the Example, below.

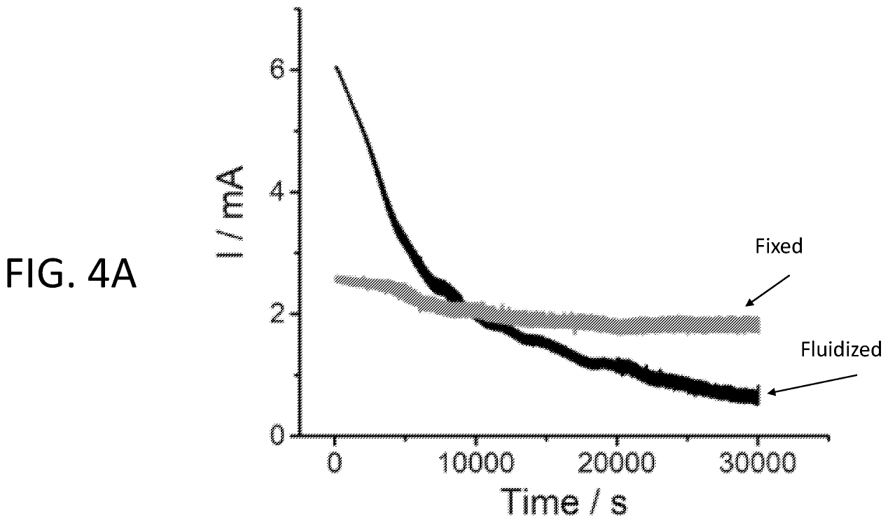

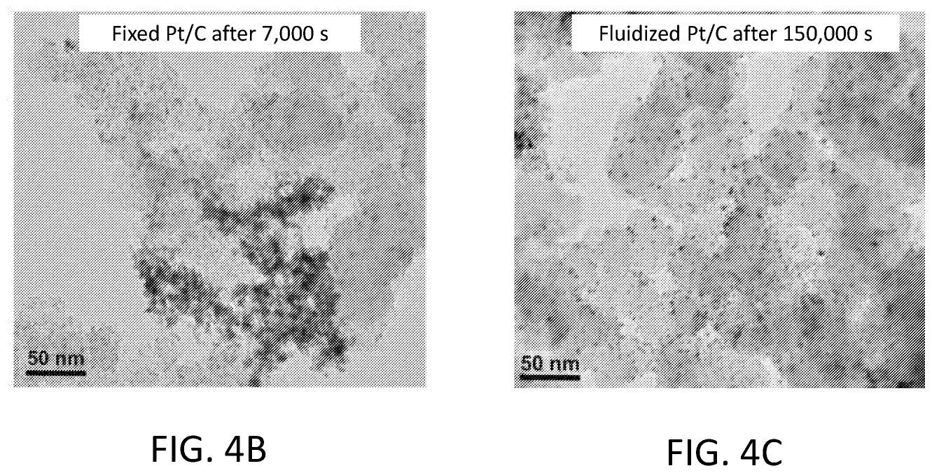

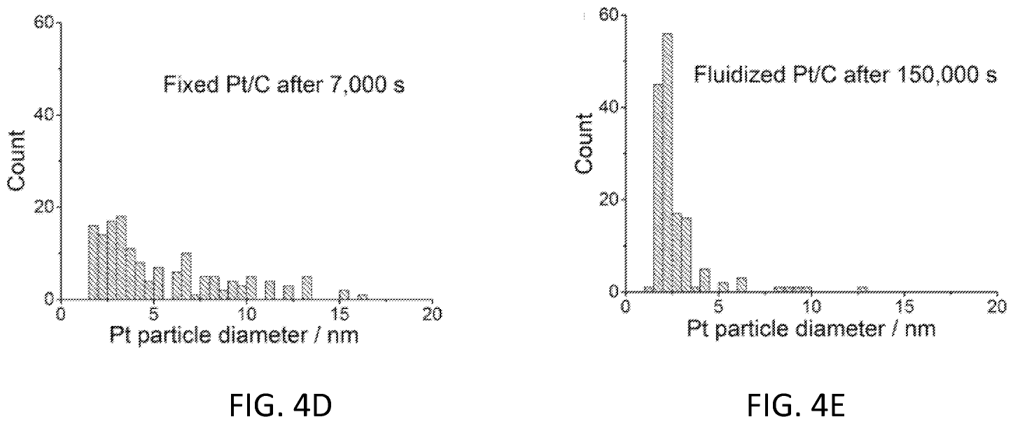

The present methods based on fluidized electrocatalysis are characterized by significantly improved fatigue resistance, e.g., as compared to methods involving comparative electrocatalysts having the same composition as the fluidized electrocatalyst particles but which are deposited (i.e., static/fixed) on the working electrode. Fatigue resistance may be measured from current versus time plots and reported as a percentage of an initial current obtained from an electrochemical cell comprising the fluidized electrocatalyst particles after a certain period of time. The initial current may be a current measured slightly after time equals zero, rather than the current at exactly time equals zero. This is to exclude initial irregularities in current due to non-reaction factors. By way of illustration, in FIG. 4A for the fluidized reaction, the initial current is 2.5 mA at a time of 0. At a time of 30,000 seconds, the current is 1.8 mA. Thus, the fatigue resistance is 72% after 30,000 seconds. In embodiments, the fatigue resistance is at least about 50%, at least about 60%, at least about 70%, at least about 80%, or at least about 90% of an initial current (at a time of about zero), after a time of about 10,000 sec, about 20,000 sec, about 30,000 sec, about 50,000 sec, about 100,000 sec, or about 150,000 sec. These fatigue resistance values may refer to a particular electrochemical reaction and a particular set of conditions. Any of the electrochemical reactions and conditions described in the Example, below, may be used with reference to these fatigue resistance values.

Related to fatigue resistance, the present methods based on fluidized electrocatalysis may also be characterized by significantly lower current decay rates, e.g., as compared to methods involving comparative electrocatalysts having the same composition as the fluidized electrocatalyst particles but which are deposited (i.e., static/fixed) on the working electrode. Current decay rates may be measured from current versus time plots (e.g., those from which fatigue resistance is measured) and reported as the percentage of the current decay over time. By way of illustration, in FIG. 4A for the fluidized reaction, the initial current is 2.5 mA at a time of 0. At a time of 30,000 seconds, the current is 1.8 mA. Thus, the current decay rate is 28% over 30,000 seconds. In embodiments, the current decay rate is no more than about 30%, no more than about 25%, no more than about 20%, no more than about 15%, or no more than about 10% as measured from an initial current (at a time of about zero) to about 10,000 sec, to about 20,000 sec, to about 30,000 sec, to about 50,000 sec, to about 100,000 sec, or to about 150,000 sec. In embodiments, the current decay rate is at least about 10 times lower than that of a comparative electrocatalyst having the same composition as the fluidized electrocatalyst particles but which is deposited on the working electrode. The current decay rate of the comparative electrocatalyst would be measured identically to the fluidized electrocatalyst particles except without undergoing fluid motion as described herein. This includes embodiments in which the current decay rate is at least about 25 times lower, at least about 50 times lower, at least about 75 times lower, at least about 100 times lower, or at least about 150 times lower than that of such a comparative electrocatalyst. These current decay values may refer to a particular electrochemical reaction and a particular set of conditions. Any of the electrochemical reactions and conditions described in the Example, below, may be used with reference to these current decay values. Such improvements are extremely significant and unexpected.

In another aspect, electrochemical systems for carrying out any of the disclosed methods are also provided. In an embodiment, the system comprises an electrochemical cell configured to contain any of the disclosed electrolyte solutions, with the working electrode and the counter electrode in contact with the electrolyte solution. The working electrode and the counter electrode may be immersed in the electrolyte solution. The counter electrode may be in electrical communication with the working electrode. FIG. 1B shows components of an illustrative electrochemical system. The electrocatalytic system may further comprise a power source in electrical communication with the working electrode and the counter electrode, with the power source configured to apply the electrical potential across the working electrode and the counter electrode in order to generate free electrons for use in the electrochemical reactions. Other components may be used in the electrocatalytic system, e.g., a membrane separating the electrodes, a collection cell configured to collect the product(s), devices for facilitating fluid flow (e.g., stir bar, sonicator, pump), etc.

### EXAMPLE

### Materials and Methods

Materials. Pt/C particles, which have a nominal Pt loading of 20% on carbon black (HiSPEC™ 3000), were purchased from Alfa Aesar and used as is. H₂SO₄, methanol, and NaOH were purchased from Sigma-Aldrich. All the electrolytes were prepared with deionized water.

Electrochemical measurements. All electrochemical measurements were conducted on an Autolab potentiostat (Metrohm-Autolab). All the experiments were done with a three-electrode system at 298 K with a double-sided glassy carbon plate (25 mm×25 mm×1 mm) or a small glassy carbon disc (d=5 mm) as the working electrode (WE), a Ag/AgCl electrode as the reference electrode (RE), and a Pt plate (20 mm×20 mm) or a carbon rod as the counter electrode (CE). Unless otherwise stated, all electrochemical measurements were conducted using a glassy carbon plate as the working electrode, with an area of 500 mm² exposed in solution for fluidized reactions or modified with Pt/C for fixed electrode reactions. Both fixed electrode reactions and fluidized reactions were operated under magnetic stirring (set at 1400 rpm) in an electrochemical cell containing 50 mL electrolyte. A carbon rod was used in the hydrogen evolution reaction (HER) to avoid dissolution of the Pt from the counter electrode and re-deposition at the working electrode. Pt/C was first sonicated to disperse in water and drop casted on a glassy carbon surface or injected into the electrochemical cell (for fluidized reactions).

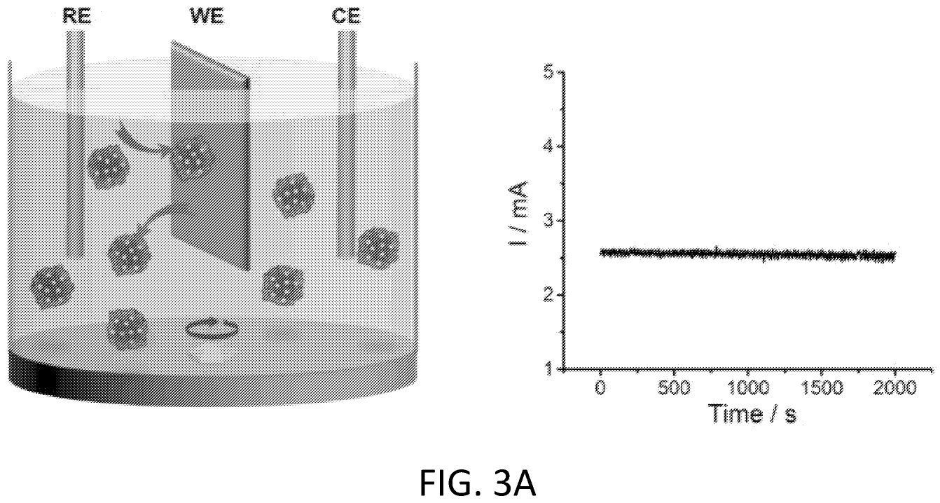

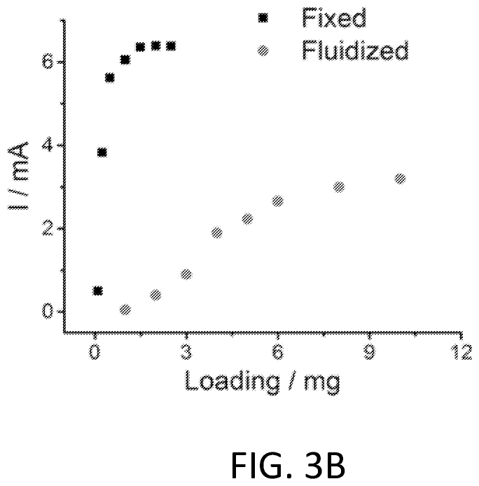

The methanol oxidation reaction (MOR) was carried out in a solution made of 0.5 M H₂SO₄ and 1 M CH₃OH under a fixed electrode potential of 0.7 V (vs. RHE). For the fluidized reaction, 5 mg Pt/C particles were dispersed in the solution under magnetic stirring, while for the fixed reaction, 2.5 mg Pt/C particles were modified on a glassy carbon plate. High-resolution chronoamperometric MOR was recorded at a glassy carbon disc of 5 mm diameter in a 50 mL solution with 5 mg Pt/C particles at 0.7 V (vs. RHE) under 1400 rpm stirring. A control experiment was done without Pt/C particles present in solution. The effect of catalyst loading on the MOR current (FIG. 3B) was studied for both fixed and fluidized Pt/C on a glassy carbon plate with an immersed area of 500 mm². The currents were extracted from the corresponding chronoamperometric profiles recorded under 0.7 V at reaction time of 500 s.

OER was carried out in a solution made of 0.1 M NaOH under a fixed electrode potential of 1.63 V (vs. RHE). HER was carried out in 0.5 M H₂SO₄ at the potential of −0.15 V (vs. RHE). The voltage was chosen so that the HER would show fast kinetics at the Pt/C electrode but would be sluggish at a bare glassy carbon electrode (data not shown). Similar to MOR, for both OER and HER, 8 mg Pt/C particles were dispersed in the electrolyte under magnetic stirring for the fluidized reaction, and 2.5 mg Pt/C particles modified on a glassy carbon plate were used for the fixed catalyst reaction.

TEM study of the catalyst before and after reaction. TEM characterization of the Pt/C before reaction and the Pt/C after fixed and fluidized reactions for MOR and OER was operated using a Hitachi H-8100 (Japan) TEM. After reaction, the fluidized Pt/C particles were collected and drop casted on TEM grids. Pt/C particles deposited on an electrode were removed from the electrodes after the reaction by gentle sonication and drop casted on TEM grids. Control experiments showed that the sonication steps did not alter the morphology of the Pt/C particles.

### Results and Discussion

Model reaction 1: Methanol oxidation reaction and its fatigue mechanisms. Commercially available Pt/C material (i.e., Pt nanoparticles on carbon black powders) was chosen as the catalyst. The methanol oxidation reaction (MOR) was chosen as one of the electrochemical reactions because its fatigue problem is notoriously complex and difficult. This is illustrated by the chronoamperometric profile of a typical MOR (data not shown), which shows the current output decaying by half after just 200 seconds. The primary fatigue mechanism for MOR has been attributed to poisoning of Pt by reaction intermediates such as CO, formic acid and/or formaldehyde, among which CO is particularly hard to remove. Applying higher potential could help to remove CO by oxidation, but this escalates other fatigue mechanisms such as electrochemical sintering of Pt nanoparticles and the formation of inactive oxides on Pt surface. Mass transport limitation of methanol to the electrode also contributes to decaying MOR performance.

Fluidized MOR: Transient current and reaction timescale. In the very early stage (e.g., within tens of milliseconds) of Pt/C catalyzed MOR, the dominating MOR intermediates are the more soluble species, such as formic acid and/or formaldehyde, after which CO generation becomes dominating. If the electrochemical reaction time scale can be shortened to just tens of milliseconds, the CO generation pathway, which is responsible for the most stubborn Pt positioning mechanism, can be suppressed. As shown below, this can be conveniently achieved in fluidized electrocatalysis. Fluidizing Pt/C particles has additional benefits, such as expedited desorption of reaction intermediates and mass transfer between the bulk solution and the surface of the particles to disrupt the buildup of a surface depletion zone. Therefore, fluidized MOR becomes quite fatigue resistant.

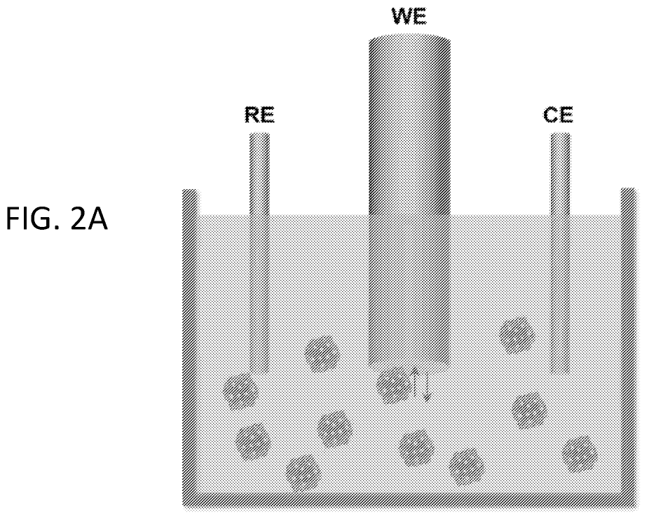

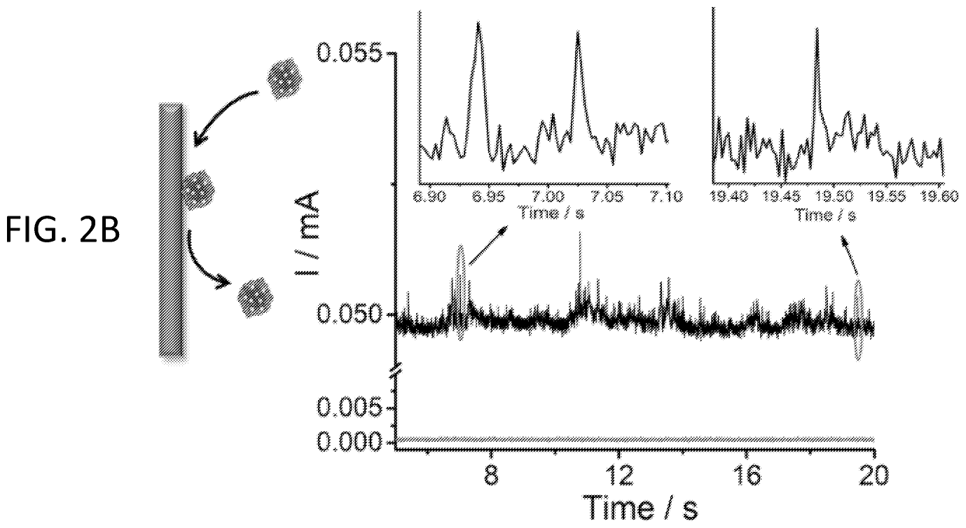

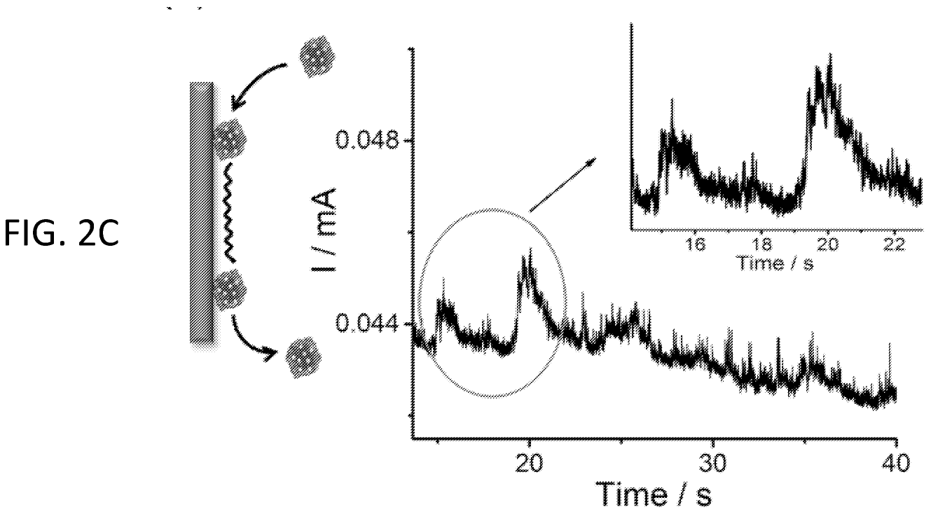

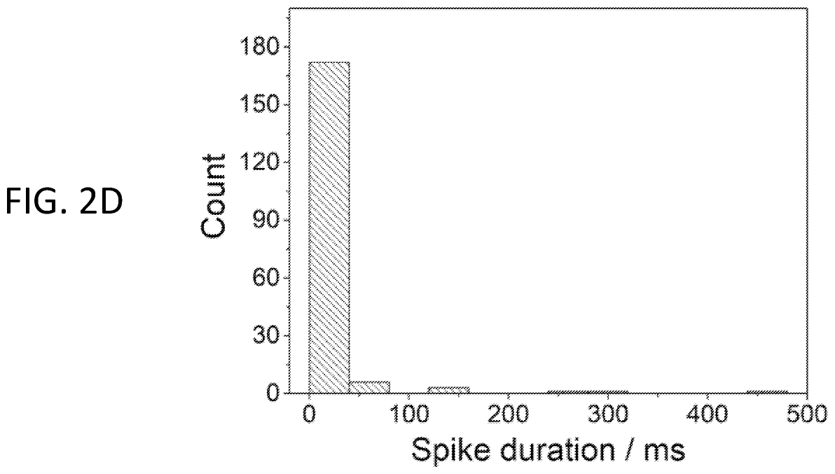

As illustrated in FIG. 2A, in a fluidized electrocatalytic reaction, the suspended Pt/C particles collide on electrode surface, collectively generating the overall current output. In order to better resolve the transient currents generated by individual collision events and reduce the frequency of such events, a small glassy carbon electrode (5 mm in diameter) was chosen for the electrochemical measurements. FIG. 2B shows a segment of the typical chronoamperometric profile of a fluidized MOR reaction, recorded with high temporal resolution. Many current “spikes” of tens of milliseconds wide were recorded, which correspond to electrochemical behavior of MOR at single Pt/C particles. It is believed that the duration of these faradic current transients corresponds to the time scale of particle catalyzed reaction during collision with the electrode. Control experiments (bottom line) showed that no current was generated without adding Pt/C particles (FIG. 2B).

There are a number of types of particle-electrode interactions. In addition to these “short stay” particles, i.e., particles that bounce away from the electrode after collision, there are also “long stay” particles that glide along the surface of the electrode before returning to solution, resulting in much longer retention time of hundreds of milliseconds or even seconds. Some examples are shown in FIG. 2C. The histogram analyzing the peak width of the current transients of the fluidized MOR reaction (FIG. 2D) shows that over 85% of spikes were shorter than 40 milliseconds. This drastically reduced the characteristic time scale of MOR and the electrochemical stress the Pt/C particles experienced from continuum down to tens of milliseconds.

Fluidized MOR: Scaling up current output. Using a small glassy carbon electrode, single particle level transients were observed. The overall current output can be readily scaled up using higher particle concentration and/or electrodes with larger areas. Indeed, by using a larger glassy carbon plate electrode (500 mm² exposed area in solution) in the fluidized reaction (FIG. 3A), much higher current output was collected. Due to the high background current from a larger electrode surface, transient current from an individual reaction can no longer be resolved, leading to a visually continuous current output collectively contributed from a high number of collision events, such as the one shown in FIG. 3A.

Adding more particles to the fluidized reaction can further increase the current output. In contrast, the current of a fixed catalyst reaction tends to saturate at a very low mass loading level of Pt/C. In fluidized reaction, only a small percentage of the particles in the electrolyte are contributing to the reaction at any given moment. However, as discussed below, the fluidized particles have much higher current efficiency than their counterparts fixed on electrode, which inevitably makes them closely packed at any practical mass loading level. This leads to much better scalability of fluidized reaction as shown in FIG. 3B, where the current output from 10 mg of fluidized Pt/C particles, although not saturated yet, already reached about half of the maximal current delivered by fixed catalysts.

Particle-average current output in fluidized vs. fixed MOR. As illustrated in FIGS. 1A-1B, fluidized catalyst particles will have much higher mass transport efficiency than those fixed on an electrode. As electrochemical reaction proceeds, particles fixed on an electrode tend to develop an expanding depletion zone before reactants can be replenished near their surface. For well isolated particles (i.e., at low loading level or low surface coverage on the electrode surface), the diffusion mode of reactants near their surface is radial, which transitions into a much less efficient linear mode as the particles are closely packed at higher loading levels. It has been found that the single particle efficiency at a very low loading level (e.g., 0.01-0.1% surface coverage of single particles) can be over two orders of magnitude higher than that from close packed particles. (Streeter, I. et al., J. Phys. Chem. C 2007, 111, 17008-17014.) Since mass transport efficiency is reflected by the Faraday current generated by single catalytic particles, the single particle efficiency (i.e., particle-average current output) of fluidized and fixed particles based on their contribution to MOR currents is compared below.

For fixed catalyst Pt/C particles, contribution from individual particles can be estimated by dividing the total catalytic MOR current by the total number of fixed particles. The density of Pt/C particles is estimated to be 2.3 g/cm³, based on the densities of carbon black (1.8 g/cm³) and Pt (21.45 g/cm³), and the Pt loading level (20 wt. %). The average diameter of dispersed Pt/C particles or clusters is taken to be around 600 nm, based on dynamic light scattering measurement (data not shown) and confirmed by TEM observations. If the shape of Pt/C particles is approximated as a sphere, the mass of one such particle is calculated to be 2.5×10⁻¹³ g. As discussed earlier and shown in FIG. 3B, for fixed Pt/C particles, their MOR current output rapidly saturated as the particle loading increased. Therefore, here the results obtained from a low particle loading level (0.2 mg) to calculate the particle-average current output were chosen. Since 0.2 mg of Pt/C contains 8×10⁸ particles and collectively delivered 3.8 mA, the particle-average contribution is calculated to be 4.8×10⁻¹² A.

The particle-average current output for fluidized Pt/C is taken to be the average current produced during a collision event, which is calculated by dividing the total Faraday charges produced in a current spike over its duration. Using the high-resolution chronoamperometric MOR profile shown in FIG. 2B, the particle-average current output from fluidized MOR is calculated to be 2×10⁻⁷ A, based on the analysis of 1000 spikes during the first few hundred seconds reaction time. This particle average efficiency in fluidized reaction is four orders of magnitude higher than that in the fixed MOR, which highlights the superiority of fluidized electrocatalytic reactions. In addition, the collective current output of fluidized reactions may be scaled up, such as by optimizing the flow profile of the electrolyte and the geometry of the electrode and reaction vessels, leading to further improvements.

Fatigue performance of fluidized vs. fixed MOR. Since particles in fluidized reaction work in rotation, they do not experience the buildup of electrochemical stress as in fixed catalyst reactions. Therefore, fluidizing the catalysts can significantly reduce the degree of degradation of the Pt nanoparticles (e.g., agglomeration or sintering), which helps maintain a stable current output. FIG. 4A shows the results of “fatigue test” (i.e., long term chronoamperometric measurement) of a fixed and a fluidized MOR under the same operating voltage of 0.7 V (vs. RHE), using identical electrodes (500 mm² double-sided glassy carbon plate). The catalyst loading levels were optimized based on the results shown in FIG. 3B, which were 2.5 mg for fixed reaction and 5 mg for fluidized reaction, so that both types of reactions started from their near-maximal currents. While the current from the immobilized Pt/C decayed by over 60% in just 7,000 seconds, the fluidized Pt/C delivered a stable current over a much longer period of 30,000 seconds. Although the initial current generated from fixed Pt/C was more than twice of that from fluidized particles, it was surpassed by the latter at around 9,000 seconds.

Transmission electron microscopy (TEM) studies revealed that Pt nanoparticles on the fixed Pt/C had been extensively displaced, agglomerated, and sintered after 7,000 seconds (FIG. 4B), while those on the fluidized particles remained unchanged even after 150,000 seconds (FIG. 4C). The changes in particle diameter is reflected in the size histogram of around 250 particles after 7,000 s fixed reaction and 150,000 s fluidized reaction shown in FIGS. 4D-4E.

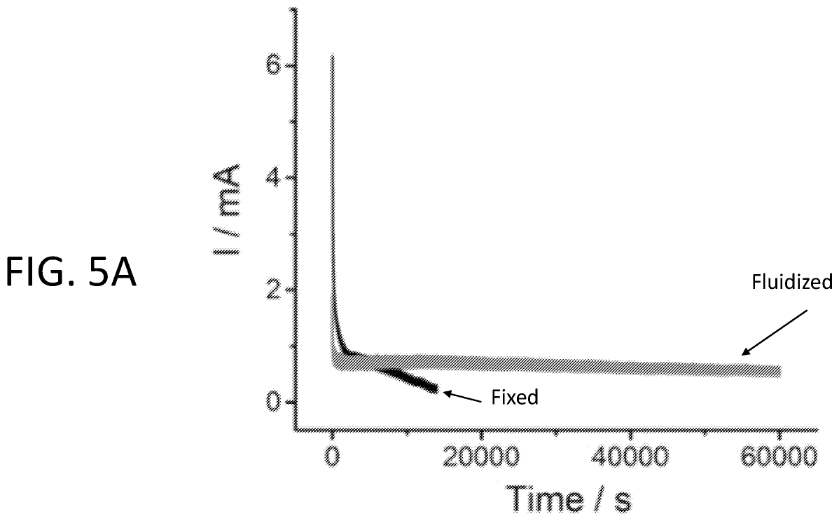

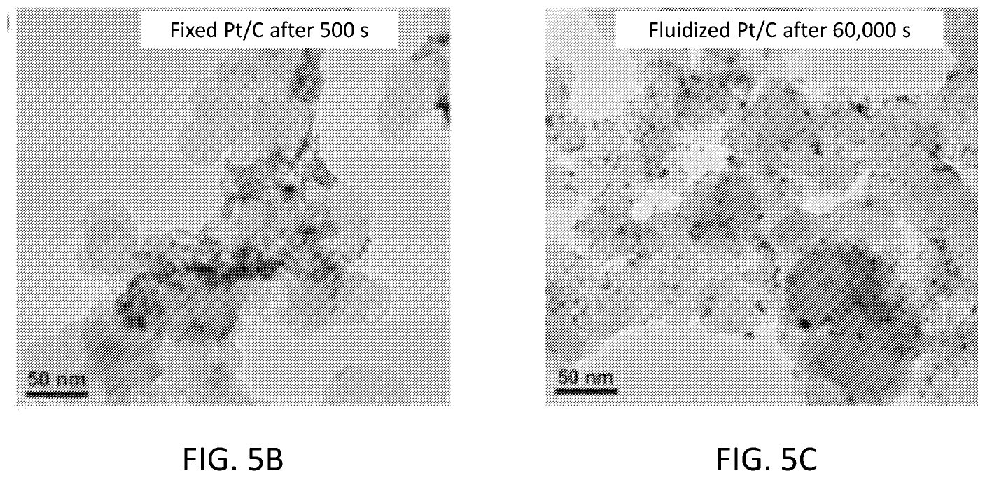

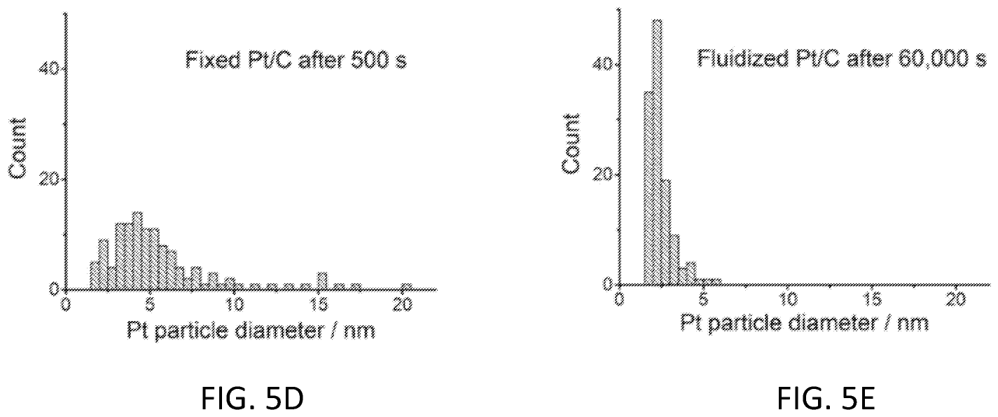

Model reaction 2: Oxygen evolution reaction (OER). Agglomeration and sintering of catalytic nanoparticles under electrochemical stress is a common degradation mechanism in electrocatalysis. Thus, the fluidized catalyst strategy is applicable to a wide variety of other types of reactions as well. For example, oxygen evolution reaction (OER) is the most energy-intensive reaction in water splitting. It is notoriously harsh for catalysts due to its high operational potential, which tends to inflict significant structural damage to the catalytic particles. Corrosion of the support materials (e.g., carbon) under such potential further escalates catalyst degradation. These problems make OER a very good model reaction to examine the effect of the fluidized strategy in increasing the fatigue resistance of electrocatalysts. FIG. 5A shows the result of a “stress test” of Pt/C particles under both fixed and fluidized conditions. As expected, the current output from the fixed Pt/C particles exhibited a sharp drop during the first few hundred seconds, and it diminished to around 1% of the initial value after 13,000 seconds. Before the reaction, the Pt nanoparticles were around 5-10 nm in diameter and evenly distributed on the carbon support. However, after just 500 seconds of reaction, the morphology of Pt/C particles had drastically changed. Most of the Pt nanoparticles had aggregated or sintered (FIG. 5B), which is a clear sign of catalyst degradation. In contrast, the fluidized Pt/C particles yielded a quite stable current (FIG. 5A) and showed no significant change in morphology (FIG. 5C) even after 60,000 seconds. The changes in particle size is reflected in the size histogram of around 250 particles after 500 s fixed reaction and 60,000 s fluidized reaction shown in FIGS. 5D-5E.

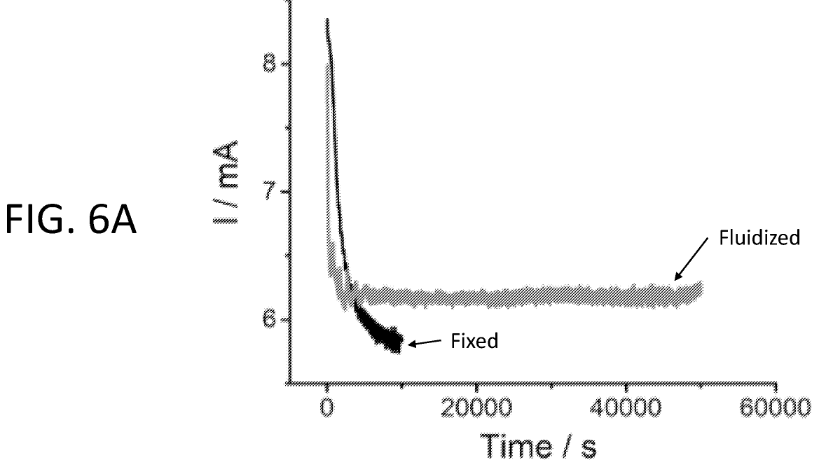

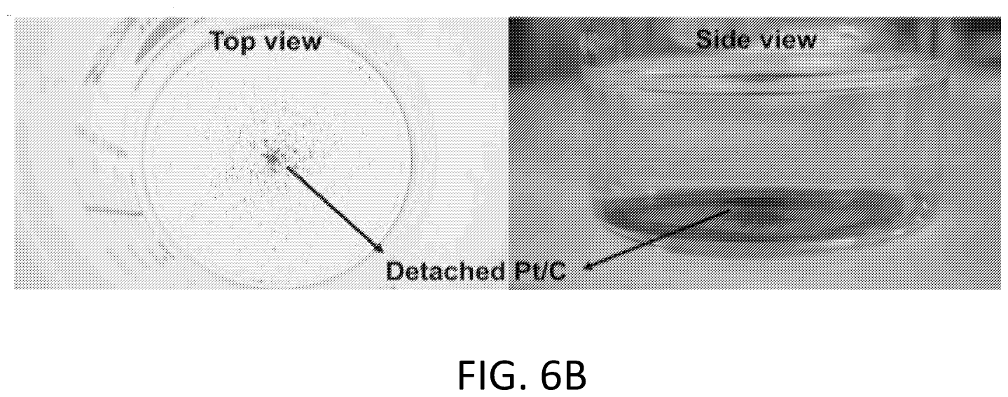

Model reaction 3: Hydrogen evolution reaction (HER). Fluidized strategy can address another fatigue mechanism due to surface pulverization or catalyst detachment during electrocatalysis. Pt/C catalyzed hydrogen evolution reaction (HER) is chosen to study this problem because Pt/C itself is quite a robust catalyst for HER, and thus it is a good model system to highlight the effect of particle detachment in performance decay. In gas evolution reactions, gas bubbles nucleate and grow in between the catalyst particles or on their surfaces and eventually leave the electrode. Electrolyte near the catalyst is repeatedly displaced and refilled during bubble evolution, applying cyclic local mechanical stress while flushing the catalytic surface particles. This tends to weaken the connection between the particles, which are held together by a binder material, or the struts of surface textures, and their adhesion on the electrodes. This is further aggravated at high gas evolution rates and high operating currents and is especially problematic if one wishes to increase the loading of catalysts. In such reactions (e.g., Pt/C catalyzed HER), even if the catalysts do not suffer significant materials degradation, pulverization or detachment from electrodes leads to rapid performance decay. Here, fluidizing the catalysts fundamentally avoids this problem. FIG. 6A compares the performance of fixed and fluidized Pt/C for HER. A current decay of 65% was observed for fixed Pt/C after 10,000 s of reaction. FIG. 6B shows the reaction cell after 10,000 s of fixed electrode reaction using a planar glassy carbon electrode, showing a significant amount of Pt/C sediment due to detachment from the electrode. In contrast, fluidized HER is free from such concern and therefore maintains 80% of the initial current after 50,000 s.

### CONCLUSION

Fluidized electrocatalysis spatially and temporally de-convolutes electron transfer from other slower molecular processes in electrocatalysis, leading to higher catalyst efficiency and better scalability. Fluidizing the catalysts avoids the buildup of electrochemical stress and suppresses or mitigates a number of degradation mechanisms of the active materials, thus drastically increasing their fatigue-resistance. The fluidized approach is largely agnostic to catalytic materials and reactions; therefore, it will work in conjunction with other strategies in catalyst design to improve the overall performance of electrocatalytic systems.

Additional details and experimental results, including results indicated as “not shown” above may be found in to U.S. Provisional Patent Application No. 62/623,680, which is hereby incorporated by reference in its entirety.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the disclosure has been presented for purposes of illustration and of description. It is not intended to be exhaustive or to limit the disclosure to the precise form disclosed, and modifications and variations are possible in light of the above teachings or may be acquired from practice of the disclosure. The embodiments were chosen and described in order to explain the principles of the disclosure and as practical applications of the disclosure to enable one skilled in the art to utilize the disclosure in various embodiments and with various modifications as suited to the particular use contemplated. It is intended that the scope of the disclosure be defined by the claims appended hereto and their equivalents.

What is claimed is:

1. A method of catalyzing an electrochemical reaction, the method comprising applying an electrical potential across a fixed working electrode and a counter electrode, the fixed working electrode and the counter electrode in contact with an electrolyte solution comprising reactant species and fluidized electrocatalyst particles, the fluidized electrocatalyst particles undergoing free fluid motion within and throughout the electrolyte solution, wherein the electrical potential is applied to induce an electrochemical reaction between the reactant species and the fluidized electrocatalyst particles at transient interfaces formed between the reactant species, the fluidized electrocatalyst particles and the working electrode upon collisions of the fluidized electrocatalyst particles with the working electrode.

2. The method of claim 1, wherein the electrochemical reaction is a methanol oxidation reaction.

3. The method of claim 1, wherein the electrochemical reaction is a hydrogen evolution reaction.

4. The method of claim 1, wherein the electrochemical reaction is an oxygen evolution reaction.

5. The method of claim 1, wherein the fluidized electrocatalyst particles comprise a noble metal or a compound of a noble metal.

6. The method of claim 5, wherein the fluidized electrocatalyst particles comprise Pt.

7. The method of claim 1, wherein the fluid motion of the fluidized electrocatalyst particles is induced by applying an external force to the electrolyte solution.

8. The method of claim 7, wherein applying the external force is achieved by stirring, sonicating or pumping the electrolyte solution.

9. The method of claim 1, characterized by a fatigue resistance of at least 80% of an initial current at a time of 20,000 sec.

10. The method of claim 9, wherein the electrochemical reaction is a methanol oxidation reaction, the applied electric potential is 0.7 V versus reversible hydrogen electrode (RHE), and the method is carried out at room temperature.

11. The method of claim 9, wherein the electrochemical reaction is a hydrogen evolution reaction, the applied electric potential is −0.15 V versus RHE, and the method is carried out at room temperature.

12. The method of claim 9, wherein the electrochemical reaction is an oxygen evolution reaction, the applied electric potential is 1.63 V versus RHE, and the method is carried out at room temperature.

13. The method of claim 1, characterized by a current decay rate that is at least 10 times lower than that of a comparative electrocatalyst having the same composition as the fluidized electrocatalyst particles but which is deposited on the working electrode.

14. The method of claim 13, wherein the current decay rate for the method is no more than 30% as measured from an initial current to at a time of 30,000 sec.

15. The method of claim 13, wherein the electrochemical reaction is a methanol oxidation reaction, the applied electric potential is 0.7 V versus reversible hydrogen electrode (RHE), and the method is carried out at room temperature.

16. The method of claim 13, wherein the electrochemical reaction is a hydrogen evolution reaction, the applied electric potential is −0.15 V versus RHE, and the method is carried out at room temperature.

17. The method of claim 13, wherein the electrochemical reaction is an oxygen evolution reaction, the applied electric potential is 1.63 V versus RHE, and the method is carried out at room temperature.
